(19) United States
(12) Patent Application Publication
(10) Pub. No.: US 2024/0273848 A1
(43) Pub. Date: Aug. 15, 2024

(54) TEXTURING METHOD FOR GENERATING THREE-DIMENSIONAL VIRTUAL MODEL, AND COMPUTING DEVICE THEREFOR

(71) Applicant: 3I INC., Daegu (KR)

(72) Inventors: Ken KIM, Seoul (KR); Ji Wuck JUNG, Goyang-si (KR); Farkhod Rustam Ugli KHUDAYBERGANOV, Seoul (KR); Mikhail LI, Paju-si (KR)

(73) Assignee: 3I INC., Daegu (KR)

(21) Appl. No.: 18/563,565

(22) PCT Filed: Nov. 23, 2022
(86) PCT No.: PCT/KR2022/018576

§ 371 Date: Nov. 22, 2023

(30) Foreign Application Priority Data
Dec. 31, 2021 (KR) 10-2021-0193901

(51) Int. Cl. G06T 19/20; G06T 15/04; G06T 17/20

(52) U.S. Cl. CPC G06T 19/20; G06T 15/04; G06T 17/20; G06T 2210/56; G06T 2219/2012

(57) ABSTRACT

According to a technical aspect of the present application, a texturing method, performable on a computing device, for creating a 3D virtual model based on a plurality of data sets, each of which is created from a plurality of shooting points in an indoor space and includes a color image and a depth image, may comprise: creating a 3D mesh model based on the created plurality of data sets; texturing each of the plurality of faces included in the 3D mesh model based on an association between the face and the color image; identifying a hole face that is displayed as a hole due to the absence of the association; and confirming a plurality of associated vertices associated with the hole face and setting a color of the hole face based on the colors of the confirmed plurality of associated vertices.

### TECHNICAL FIELD

This application relates to a texturing method for creating a 3D virtual model of an indoor space and a computing device therefor.

### BACKGROUND ART

In recent years, virtual space implementation technology has been developed that allows users to experience as if they are in a real space without directly visiting the real space by providing an online virtual space that corresponds to the real space.

This real space-based virtual technology is a technology for implementing a digital twin or metaverse, and various developments of the technology have been being conducted.

In order to implement such a virtual space, it is necessary to acquire a flat image by shooting a real space to be implemented, and based on the shot flat image, create a stereoscopic virtual image, that is, a three-dimensional (3D) virtual model to thereby provide the virtual space.

This 3D virtual model is created based on data acquired by shooting various points within the indoor space. In this case, in order to construct a 3D virtual model, color and distance data acquired at 360 degrees from various points in the indoor space are collected, and a 3D virtual model created on the basis thereof.

Since this 3D virtual model is created based on shooting indoor spaces, there is a problem in that image data cannot be obtained for blind areas of the camera when shooting, resulting in occurred holes.

### DISCLOSURE

### Technical Problem

One technical aspect of the present invention is to solve the problems of the prior all described above, and according to an embodiment disclosed in the present application, the purpose of the present invention is to effectively fill the hole faces occurred by the blind areas of the camera when shooting.

According to an embodiment disclosed in the present application, the purpose of the present invention is to effectively select an image suitable for the face of a 3D model from among a plurality of images created at various indoor points.

According to an embodiment disclosed in the present application, the purpose of the present invention is to more accurately compensate for color imbalance caused by different shooting conditions between various indoor points.

The tasks to be solved in the present invention are not limited to those mentioned above, and other tasks not mentioned herein will be clearly understood by those skilled in the art from the description below.

### Technical Solution

One technical aspect of the present invention proposes a texturing method of creating a 3D virtual model. The texturing method, performable on a computing device, for creating a 3D virtual model based on a plurality of data sets, each of which is created from a plurality of shooting points in an indoor space and includes a color image and a depth image, may comprise: creating a 3D mesh model based on the created plurality of data sets; texturing each of the plurality of faces included in the 3D mesh model based on an association between the face and the color image; identifying a hole face that is displayed as a hole due to the absence of the association; and confirming a plurality of associated vertices associated with the hole face and setting a color of the hole face based on the colors of the confirmed plurality of associated vertices.

Other technical aspect of the present invention proposes a computing device. The computing device may comprise a memory for storing one or more instructions and at least one processor for executing the one or more instructions stored in the memory, wherein the one or more instructions cause, when executed by the at least one processor, the at least one processor to, prepare a plurality of data sets, each of which is created from a plurality of shooting points in an indoor space and includes a color image and a depth image; create a 3D mesh model based on the created plurality of data sets; texture each of the plurality of faces included in the 3D mesh model based on an association between the face and the color image; identify a hole face that is displayed as a hole due to the absence of the association; and confirm a plurality of associated vertices associated with the hole face and set a color of the hole face based on the colors of the confirmed plurality of associated vertices.

Another technical aspect of the present invention proposes a storage medium. The storage medium is a storage medium that stores computer-readable instructions. The instructions, when executed by a computing device, cause the computing device to perform the operations of: preparing a plurality of data sets, each of which is created from a plurality of shooting points in an indoor space and includes a color image and a depth image; creating a 3D mesh model based on the created plurality of data sets; texturing each of the plurality of faces included in the 3D mesh model based on an association be ween the face and the color image; identifying a hole face that is displayed as a hole due to the absence of the association; and confirming a plurality of associated vertices associated with the hole face and set a color of the hole face based on the colors of the confirmed plurality of associated vertices.

The means for solving the above problems do not enumerate all the features of the present application. Various means for solving the problems of this application can be understood in more detail by referring to specific embodiments in the detailed description below.

### Advantageous Effects

According to the present application, there is one or more of the following effects.

According to an embodiment disclosed in the present application, there is an effect that is capable of accurately filling the hole face with efficient resources by filling the hole face using the point color of the point cloud.

According to an embodiment disclosed in the present application, there is an effect that is capable of more accurate texturing even in a 3D creation environment based on images shot at various points spaced apart from each other in indoor space by effectively selecting an image suitable for the face of a 3D model.

According to an embodiment disclosed in the present application, there is an effect that is capable of accurately compensating the color imbalance caused by different shooting conditions between various points in indoor space to thereby minimize the sense of heterogeneity on each side of the virtual indoor space and provide a texture of a virtual space more similar to the real space.

The effects of the present application are not limited to those mentioned above, and other effects not mentioned will be clearly understood by those skilled in the art from the detailed description of the application.

### DESCRIPTION OF DRAWINGS

FIG. 1 is an example diagram for explaining a system that provides a texturing method for creating a 3D virtual model according to an embodiment disclosed in the present application.

FIG. 2 is a flowchart explaining a texturing method for creating a 3D virtual model according to an embodiment disclosed in the present application.

FIG. 3 is a flowchart explaining a texturing method for creating a 3D virtual model according to an embodiment disclosed in the present application.

FIGS. 4 to 7 are diagrams illustrating an example of acquiring a color image according to an embodiment disclosed in this application.

FIG. 8 is a flowchart explaining a method of selecting a color image for creating a 3D virtual model according to an embodiment disclosed in the present application.

FIGS. 9 to 12 are diagrams illustrating an example of selecting a color image according to an embodiment disclosed in this application.

FIG. 13 is a flowchart explaining a method of setting an unseen face for creating a 3D virtual model according to an embodiment disclosed in the present application.

FIGS. 14 and 15 are diagrams illustrating, an example of unseen face setting according to an embodiment disclosed in the present application.

FIG. 16 is a flowchart explaining a color correction method for creating a 3D virtual model according to an embodiment disclosed in the present application.

FIGS. 17 to 18 are diagrams illustrating an example of color correction according to an embodiment disclosed in the present application.

FIG. 19 is a flowchart illustrating an unseen area texturing method for creating a 3D virtual model according to an embodiment disclosed in the present application.

FIG. 20 is a diagram illustrating an example of unseen area texturing according to an embodiment disclosed in the present application.

FIG. 21 is a block diagram illustrating a computing device according to an embodiment disclosed in the present application.

### MODE FOR INVENTION

Hereinafter, preferred embodiments of the present application will be described with reference to the attached drawings. However, these embodiments do not represent the entire technical spirit of the present invention, and should be understood to include various modifications, equivalents, and/or alternatives of the embodiments of the present disclosure.

In describing the present disclosure, if it is determined that a detailed description of related known functions or configurations may unnecessarily obscure the gist of the present disclosure, the detailed description thereof will be omitted.

The terms as used in this disclosure are merely used to describe specific embodiments and are not intended to limit the scope of the rights. Singular expressions include plural expressions unless the context clearly indicates otherwise.

In the present disclosure, expressions such as “have,” “may have,” “include,” or “may include” refer to the presence of the corresponding features (e.g., components such as numerical value, function, operation or part) and does not rule out the existence of additional features.

In connection with the description of the drawings, similar reference numerals may be used for similar or related components.

The singular form of a noun corresponding to an item may include one or more of the above items, unless the relevant context clearly indicates otherwise. In this application, each of phrases such as “A or B”, “at least one of A and B”, “at least one of A or B”, “A, B or C”, “at least one of A, B and C” and “A, and “at least one of B, or C” may include any one of the items listed together in the corresponding phrase among the phrases or any possible combination thereof.

Terms such as “first” and “second” may be used simply to distinguish one element from another element and limit corresponding elements in other aspects (e.g. importance or order).

When one (e.g., first) element is referred to as “coupled” or “connected” to another (e.g., second) element, with or without the terms “functionally” or “communicatively.” it means that any component can be connected to the other component directly or through a third component.

The expression “configured to (or set to)” as used in the present disclosure can be used interchangeably with, for example, “suitable for,” “having the capacity to,” “designed to,” “adapted to,” “made to,” or “capable of” depending on the situation. The expression “configured (or set to)” may not necessarily mean just “specifically designed to” in hardware.

Instead, in some contexts, the expression “a device configured to” may mean that the device is “capable of” working with other devices or components. For example, the phrase “processor configured (or set) to perform “A, B and C” may mean a processor (e.g., an embedded processor) dedicated to performing the corresponding operations or a general-purpose processor (e.g., CPU or application processor) capable of performing the corresponding operations by executing one or more software programs stored on a memory device.

In an embodiment, a ‘module’ or ‘unit’ performs at least one function or operation, and may be implemented as hardware or software, or as a combination of hardware and software.

Also, a plurality of ‘modules’ or a plurality of ‘units’ may be integrated into at least one module and implemented with at least one processor, except for ‘module’ or ‘unit’ that needs to be implemented with specific hardware.

Various embodiments of the present application may be implemented with a software (e.g., program) including one or more instructions stored in a storage medium that can be read by a machine (e.g., user terminal 500 or computing device 300). For example, it may be implemented as a program). For example, the processor 330 may call at least one instruction among one or more instructions stored from a storage medium and execute it. This allows the device to be operated to perform at least one function according to the at least one instruction called. The one or more instructions may include codes created by a compiler or codes that can be executed by an interpreter. A storage medium that can be read by a machine may be provided in the form of a non-transitory storage medium. Here, the term ‘non-transitory’ only means that the storage medium is a tangible device and does not contain signals (e.g., electromagnetic waves), and this term does not distinguish the case that the data is semi-permanently stored in the storage medium and the case that the data is temporarily stored in the storage medium.

Various flowcharts are disclosed to explain the embodiments of the present application, but these are for convenience of explanation of each step or operation, and each step is not necessarily performed according to the order of the flowchart.

That is, each step in the flowchart may be performed simultaneously, in an order according to the flowchart, or in an order opposite to the order in the flowchart.

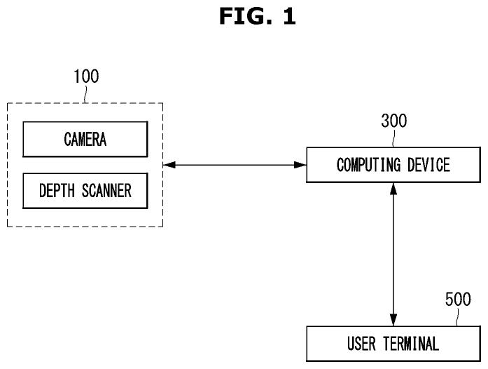

FIG. 1 is an example diagram for explaining a system that provides a texturing method for creating a 3D virtual model according to an embodiment disclosed in the present application.

The system that provides a texturing method for creating a 3D virtual model may include an image acquisition device 100, a computing device 300, and a user terminal 500.

The image acquisition device 100 is a device that creates color images and depth map images used to create spherical virtual images.

In the example shown, the image acquisition device 100 may include a ranging device, in the example shown, a depth scanner and a camera.

The camera is a device that provides a shooting function, and creates color images expressed in color for the subject area (imaging area).

In the specification of this application, the color image encompasses all images expressed in color, and is not limited to a specific expression scheme. Therefore, color images can be applied in various standards, such as RGB images expressed in red, green and blue (RGB) as well as CMYK images expressed in cyan, magenta, yellow and key (CMYK).

As an example, mobile phones, smart phones, laptop computers, personal digital assistants (PDAs), tablet PCs, ultrabooks, wearable devices, for example, a glass-type terminal (smart glass), etc. may be used as the camera

A depth scanner is a device that can create depth map images by creating depth information about the subject space (i.e., a region to be captured).

In specification of the present application, the depth map image is an image containing depth information about the subject space. For example, each pixel in the depth map image may be information about a distance to each point (a point corresponding to each pixel) of the subject space photographed in the imaging point.

The depth scanner creates such depth map image and may include a sensor for measuring distance, such as a LiDAR sensor, an infrared sensor and an ultrasonic sensor. Alternatively, the depth scanner may include a stereo camera, a stereoscopic camera, a 3D depth camera, etc. that can measure distance information by replacing the sensor.

The camera creates a color image of the subject space, and the depth scanner creates a depth map image of the subject space. The color image created by the camera and the depth map image created by the depth scanner can be created under the same conditions (e.g., resolution, etc.) for the same subject space, and as a result, they can be matched 1:1 with each other.

These color images and depth map images may be 360-degree panoramic images. The depth scanner and camera may create a 360-degree panoramic image of a real indoor space, that is, a 360-degree depth map panoramic image and a 360-degree color panoramic image, respectively, and provide them to the computing device 300. Alternatively, in accordance with the embodiment, the computing device 300 may create a 360-degree depth map panoramic image and a 360-degree color panoramic image based on data received from the depth scanner and camera.

The depth scanner can create distance information of each of several points indoors where such 360-degree imaging has been performed. This distance information may be relative distance information on the basis of the shooting point. For example, the depth scanner may have a floor plan of an indoor space and receive input of the first indoor point within the floor plan according to a user's input. Thereafter, the depth scanner may create relative distance movement information based on image analysis and/or movement detection sensors (for example, 3-axis acceleration sensor and/or gyro sensor). For example, the depth scanner may create information about a second indoor point based on relative distance movement information from the starting indoor point and create information about a third indoor point based on relative distance movement information from the second indoor point. Alternatively, the creation of such distance information may be performed by a camera.

In one embodiment, the depth scanner and camera can be implemented as a single image acquisition device. For example, the image acquisition device 100 may be a smartphone that includes a camera for image acquisition and a LiDAR sensor for distance measurement. In accordance with the embodiment, a cradle device which the smart phone is mounted thereon and rotates the smart phone 360 degrees under the control of the smart phone and the smart phone may be implemented as a single image acquisition device.

The depth scanner or camera may store information about the shooting height and provide the information to the computing device 300. This shooting height information can be used to create a 3D virtual model in the computing device 300.

The depth map image and the color image may be a panoramic image of a type suitable to provide a 360-degree image, for example, an equirectangular projection panoramic image. However, for convenience of explanation, hereinafter they are collectively referred to as depth map image and color image without distinction.

The user terminal 500 is an electronic device that allows a user to access the computing device 300 and experience a virtual 3D model corresponding to an indoor space, and may include, for example, a mobile phone, a smart phone, a laptop computer, digital broadcasting terminal, a personal digital assistants (PDA), a portable multimedia player (PMP), navigation, a personal computer (PC), a tablet PC, an ultrabook, and a wearable device such as a watch-type terminal (smartwatch), a glass-type terminal (smart glass) and a head mounted display (HMD). However, besides that, the user terminal 500 may include electronic devices used for a virtual reality (VR) and an augmented reality (AR).

The computing device 300 may create a 3D virtual model, which is a 3D virtual space corresponding to the indoor space, using color images and depth map images created at various indoor points, respectively.

The computing device 300 is a virtual space corresponding to a real space, and can create a 3D model based on color images and depth images (depth map images) created from a plurality of indoor shooting points. The 3D model is a virtual model on which depth information has been reflected and may provide a stereoscopic space equivalent to reality.

The computing device 300 may create, based on a plurality of data sets each of which is created from a plurality of shooting points in an indoor space and includes a color image, a depth image and location information of each point, a plurality of point sets (for example, point cloud) on three dimensions, and create a 3D mesh model based on this point set. The 3D mesh model may be a mesh model made by setting a plurality of faces (or polygons) based on a plurality of vertices which have been selected based on the point cloud. As an example, one face can be created on the basis of three adjacent vertices, and each face can be a flat triangle which is formed by three vertices.

Once each face is determined in the 3D mesh model, the computing device 300 may set the color value of each face based on the color image associated with each face.

The color image associated with the face can be set based on a direction vector perpendicular to the face.

The computing device 300 may select one color image to set the color value of each face, and to this end, calculate a plurality of weight factors for each color image and then calculate the weight based on them. The computing device 300 may select any one color image based on the weight.

The computing device 300 may perform color filling for the unseen face. The unseen face refers to a face that is not displayed in a captured image. For example, a plane (for example, the top of a refrigerator) higher than the shooting point is not shot by the camera and is therefore set as an unseen face. The computing device 300 may fill the unseen face with color based on the color information of the vertex.

The computing device 30U may perform color correction on a 3D model created by completing color filling for each face.

Even if shooting is done with the same camera in this invention, shooting conditions at various points in the indoor space are different. The shooting conditions such as the level of brightness, additional light source and color of the light source at each point in the indoor space are different even if the indoor space is the same. For example, natural light from the sun may be added at an indoor shooting point near a window, and illumination may be low at an indoor shooting point where the lights are turned off, which may change the camera's shooting conditions. In this way, since the shooting conditions are different at various points in the indoor space, each color image has different color values even for the same subject. Therefore, if one subject has a plurality of faces, and each face is textured based on a different color image, stains may occur in the color expression of one subject. Computing device 300 may perform color correction to compensate for the stains. Such color correction may be performed by reflecting elements resulting from differences between various shooting points in an indoor space.

As discussed above, the 3D model in the present invention has a special environment due to conditions for creating a virtual space corresponding to the indoor space. That is, it is required to acquire color images and depth images of the indoor space, and to this end, color images and depth images are acquired from a plurality of indoor shooting points. Meanwhile, the more indoor points from which images are acquired, the greater the amount of data for the 3D model, thereby improving the expression of the 3D model. However, according to the embodiments of the present invention, the expression (for example, texturing) of 3D model can be improved by processing in the computing device 300 and thus a high-quality 3D model can be acquired even if the number of indoor shooting points for indoor image acquisition is set to an appropriate number.

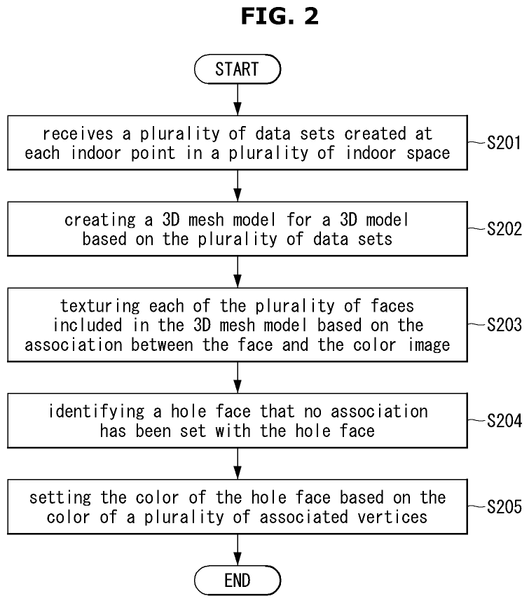

Hereinafter, this computing device 300 will be described in more detail with reference to FIGS. 2 to 15.

FIG. 2 is a flowchart explaining a texturing method for creating a 3D virtual model according to an embodiment disclosed in the present application.

Referring to FIG. 2, the computing device 300 receives a plurality of data sets created at each indoor point in a plurality of indoor space from the image acquisition device 100 (S201). The plurality of data sets are created from each indoor point in an real indoor space and may include, for example, a 360-degree color image and a 360-degree depth image.

The computing device 300 may create a 3D mesh model based on the plurality of data sets (S202).

The computing device 300 may project a plurality of shooting points in an indoor space onto a 3D coordinate system and set a plurality of 3D reference coordinates corresponding to each of the plurality of shooting points. As an example, the plurality of data sets may include a location information in addition to color images and depth images, and the computing device 300 uses this location information to set the plurality of 3D reference coordinates corresponding to each of the plurality of shooting points. In one embodiment, this location information may be relative distance information from the previous shooting point to the current shooting point, and reflects the relative distance information on the basis of the first starting indoor point to set 3D reference coordinates corresponding to each of the plurality of shooting points. The computing device 300 may create a point cloud in a 3D space by reflecting the color image and depth image created at each shooting point on the basis of the 3D reference coordinates of the plurality of shooting points. For example, the computing device 300 may reflect the color image data and depth image data created from a plurality of shooting points into 3D reference coordinates to create point cloud data including a plurality of points set in the 3D space. The computing device 300 may set a plurality of vertices by selecting at least some of the plurality of points constructing the point cloud. A 3D mesh model can be constructed based on the plurality of vertices selected in this way.

That is, the 3D mesh model can be expressed as a plurality of vertices expressed as coordinates in 3D space, and a face (or polygon), which is a polygonal face defined using those vertices. Here, each vertex has unique 3D coordinate and may also have color data. That is, the color of each vertex can be set based on the data of the color image associated with each vertex. For example, each of the points has unique 3D coordinates and color in 3D space by reflecting the color of the color image and the distance in the depth image on the basis of the 3D reference coordinates. For example, the color image and the depth image may be created on the basis of the same shooting standard and correspond to each other 1:1, and each pixel of the color image may have a color value and each pixel of the depth image may have a depth value. The computing device 300 may form a point cloud by reflecting these color value and depth value in the reference coordinates. Vertices are selected based on this point cloud and can likewise have 3D coordinate value and color value.

In one embodiment, the computing device 300 may divide the 3D point cloud into a predetermined unit space, set one point representing a plurality of points included in the unit space, and set a vertex based on it. The computing device 300 may set a plurality of points included in a predetermined unit space (for example, 1 cubic centimeter) as one point. As one example, the computing device 300 may set one point based on the average color value and average coordinate value of the plurality of points included in the predetermined unit space. As another example, the computing device 300 may set one point based on the central color value and central coordinate value of a plurality of points included in a predetermined unit space. In these examples, the computing device 300 may perform normalization of the same points and then select vertices forming a predetermined surface based on these points and determine them as vertices.

The computing device 300 may perform texturing on each of the plurality of faces included in the 3D mesh model based on the association between the face and the color image (S203).

The computing device 300 may identify a hole face (the hole face is displayed as a hole because the color data value has not been selected and the hole is referred to as a hole face) for which no association has been set in step S203 (S204), and identifies a hole face associated with the hole face. The color of the hole face can be set based on the color of a plurality of associated vertices (S205).

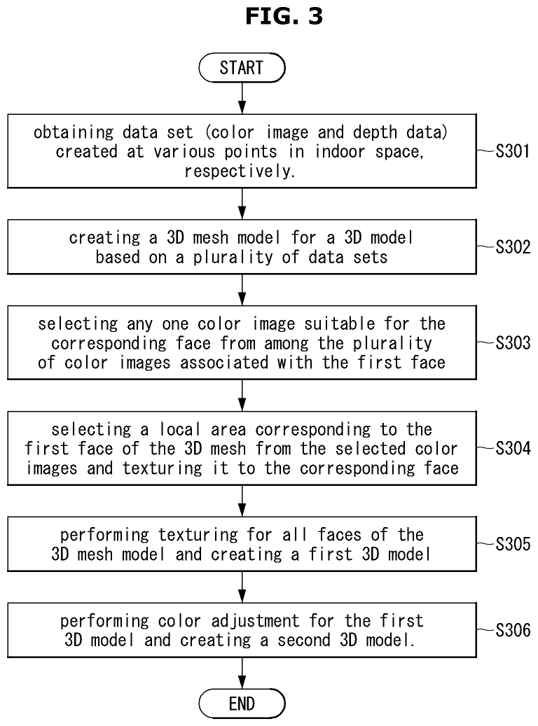

FIG. 3 is a flowchart explaining a texturing method for creating a 3D virtual model according to another embodiment disclosed in the present application.

Referring to FIG. 3, the computing device 300 receives a plurality of data sets created at each indoor point in a plurality of indoor spaces from the image acquisition device 100 (S301). Here, the data set includes a color image shot at that point, a depth image, and location information about that indoor point.

The computing device 300 creates a 3D mesh model for creating a 3D model of an indoor space based on a plurality of data sets (S302).

The 3D mesh model may be created by creating a plurality of point sets (e.g., point clouds) created based on color images and depth images for each indoor point and arranging them in 3D space based on the location information.

The computing device 300 may select a plurality of vertices based on the point clouds and set a plurality of faces based on the selected vertices to create a 3D mesh model. As an example, the computing device 300 may set one triangle face on the basis of three adjacent vertices.

Since color values has not yet been set for the faces in this 3D mesh model, the computing device 300 repeats steps S303 to S304 to set color values (that is, to perform texturing) for each face.

The computing device 300 may select any one (first) face of a plurality of faces included in the 3D mesh model, and select any one first color image suitable for the first face from among the plurality of color images associated with the first face, can be selected (S303).

Here, in selecting color images associated with the first face, the computing device 300 may calculate a unit vector perpendicular to the first face and based on this, select at least one color image having a shooting angle corresponding to the unit vector as a color image associated with the face. Since information about the shooting angle of the color image is also created when shooting the color image, the computing device 300 may select the color image associated with the first face (that is, the color image having the first face shot) based on information about the shooting height and shooting angle for the color image. For example, the computing device 300 may select a color image having a unit vector perpendicular to the first face and a shooting angle opposing thereto within a predetermined angle (that is, facing each other within a predetermined angle) as the color image associated with the face.

The computing device 300 may select a color image suitable for the corresponding face from among color images associated with the face. For example, the computing device 300 may produce a plurality of weight factors for each related color image, calculate a weight based on them, and then select any one color image based on the weight.

As an example, the first color image matching the first face may be selected by evaluating based on the shooting direction, resolution, and color noise for the first face among a plurality of color images associated with the 3D mesh model.

The computing device 300 may perform texturing by selecting a local area corresponding to the first face from one of the selected color images and mapping it to the first face (S304).

Since the computing device 300 has information about the shooting location of each color image, each object in each color image and each object in the 3D mesh model can be projected and mapped. Therefore, based on the projection mapping of this 2D color image and the 3D mesh model, a local area in the 2D color image corresponding to the face can be selected.

The computing device 300 may repeat steps S303 to S304 described above for all faces of the 3D mesh model, create color information for each face and perform texturing (S305). Since the 3D model created in this way has not undergone color correction between respective color images, stains may occur even on the same surface. This is because, as described above, the shooting environment at each indoor shooting point is different.

the computing device 300 may perform color adjustment to correct color differences due to the shooting environment at each indoor shooting point (S306).

The embodiment shown in FIG. 2 and the embodiment shown in FIG. 3 are described separately, but may be implemented in combination with each other, such as replacing each step together.

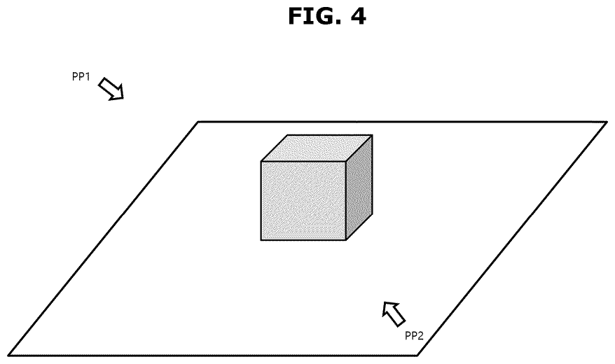

FIGS. 4 to 7 are diagrams illustrating an example of acquisition of a color image according to embodiments disclosed in this application, and the embodiments will be described with reference to them.

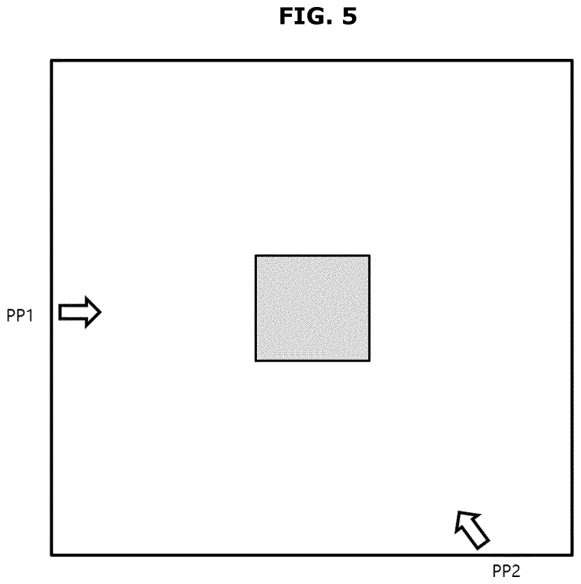

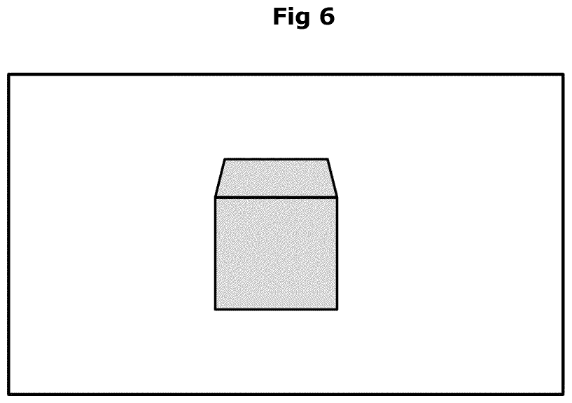

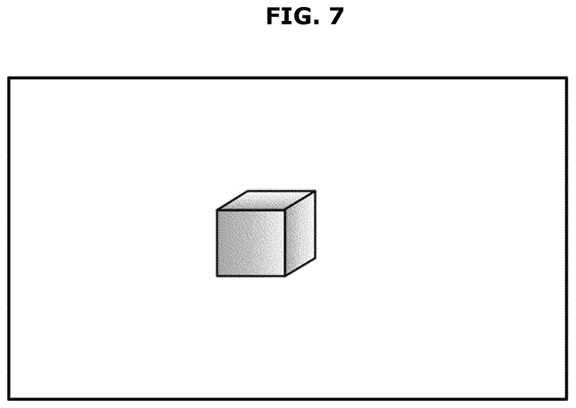

FIG. 4 is a perspective view showing, as an example, a hexahedral subject in an indoor space and a first indoor shooting point PP1 and a second shooting point PP2 in relation hexahedral subject, and FIG. 5 is a plan view corresponding to FIG. 4. FIG. 6 shows an example of a color image shot at the first shooting point PP1, and FIG. 7 shows an example of a color image shot at a second shooting point PP2.

FIGS. 6 and 7 show an example in which color images have been shot for the same subject, but color changes have occurred due to shading in FIG. 7.

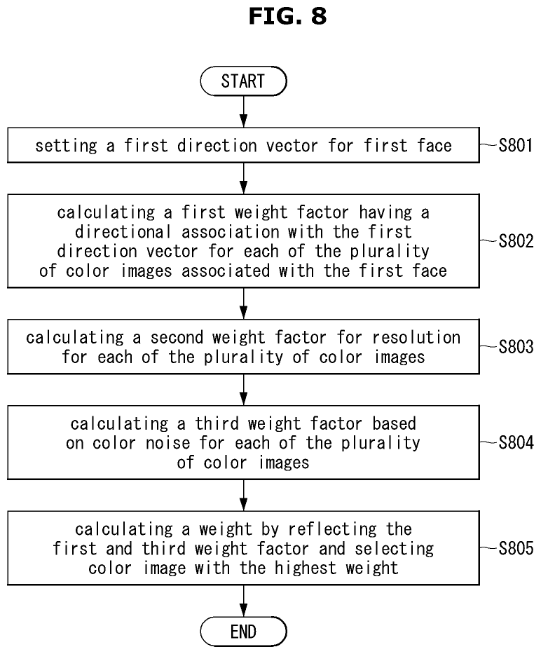

FIG. 8 is a flowchart explaining a method of selecting a color image for creating a 3D virtual model according to embodiments disclosed in the present application.

One embodiment shown in FIG. 8 relates to an embodiment of determining an association between a face and a color image performed on the computing device 300. In FIG. 8, three weights for determining the association are disclosed, but it is obvious that these three weights can be used in various combinations depending on embodiments.

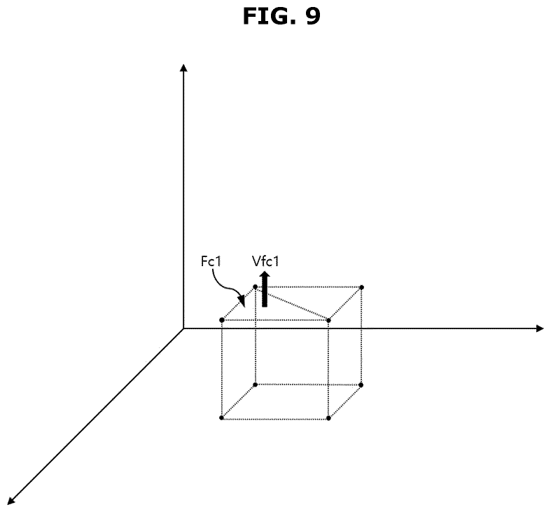

The flowchart shown in FIG. 8 relates to a process of selecting a first color image to be mapped to the first face from among a plurality of color images associated with the first face. FIGS. 9 to 12 are diagrams illustrating an example of selecting a color image according to an embodiment disclosed in the present application, and will be further described with reference to these.

Referring to FIG. 8, the computing device 300 may set a reference vector for the first face of the 3D mesh model, that is, a first direction vector perpendicular to the first face (S801).

The computing device 300 may calculate a first weight factor having a directional association with the first direction vector for each of the plurality of color images associated with the first face (S802).

The computing device 300 may check the shooting direction of the plurality of color images associated with the first face and calculate a first weight factor based on the directional association between the first direction vector of the first face and the shooting direction. For example, the smaller the angle between the first direction vector of the first face and the shooting direction, the higher the weight factor can be calculated.

The computing device 300 may calculate a second weight factor for resolution for each of the plurality of color images associated with the first face (S803).

As an example, the computing device 300 may check the resolution of the plurality of color images themselves and calculate a second weight factor based on the resolution.

That is, the higher the resolution, the higher the second weight factor can be calculated.

As another example, the computing device 300 may identify an object that becomes a target of texturing or a face that is part of the object, and calculate a second weight factor based on the resolution of the identified object or face. Since the resolution for such an object or face is s t in inverse proportion to the distance between objects at the shooting point, a higher second weight is given to a color image that is advantageous in terms of distance.

The computing device 300 may calculate a third weight factor for color noise for each of the plurality of color images associated with the first face (S804).

The computing device 300 may calculate color noise for each color image. To calculate the color noise, various methodologies can be applied, such as an unsupervised learning using DCGAN (Deep Convolutional Creative Adversarial Network) and a method using Enlighten GAN.

The computing device 300 may make that the smaller the color noise, the higher the third weight factor is assigned.

The computing device 300 may calculate a weight for each of the plurality of color images by reflecting the first to third weight factors. The computing device 300 may select one color image with the highest weight as the first image mapped to the first face (S805).

Various algorithms can be applied in reflecting the first to third weight factors. For example, the computing device 300 may calculate the weight in various ways, such as simply summing the first to third weight factors or deriving an average thereof.

In the above example, it has been exemplified that all of the first to third weight factors are reflected, but it is not limited thereto. Accordingly, modifications such as calculating the weight based on the first weight factor and the second weight factor or calculating the weight based on the first weight factor and the third weight factor can be implemented. However, even in this modification, it is desirable to include the first weight factor for providing higher performance.

FIG. 9 shows an example of setting a first direction vector perpendicular to the first face Fc1 in the hexahedron.

Referring to the example shown in FIGS. 9 and 4, it can be seen that the first shooting point PP1 will have a higher first weight than the second shooting point PP2.

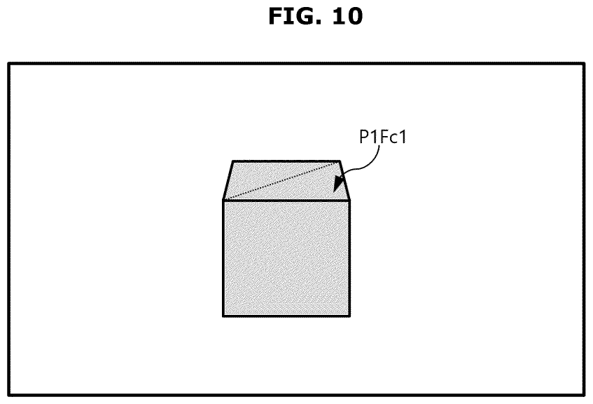

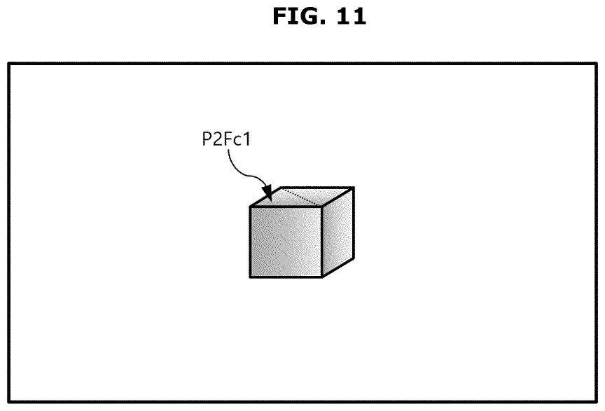

FIG. 10 illustrates a local area P1Fc1 corresponding to the first face in the color image at the first shooting point PP1, and FIG. 11 illustrates a local area P2Fc1 corresponding to the first face in the color image at the second shooting point PP2.

Referring to FIGS. 10 and 11, it can be seen that the color image at the first shooting point PP1 shown in FIG. 10 has a higher resolution than the color image in FIG. 11, so the second weight factor will be higher.

The color noise will be set higher in the color image at the second shooting point PP2 shown in FIG. 11, and therefore, the first shooting point PP1 shown in FIG. 10 will have a higher third weight factor.

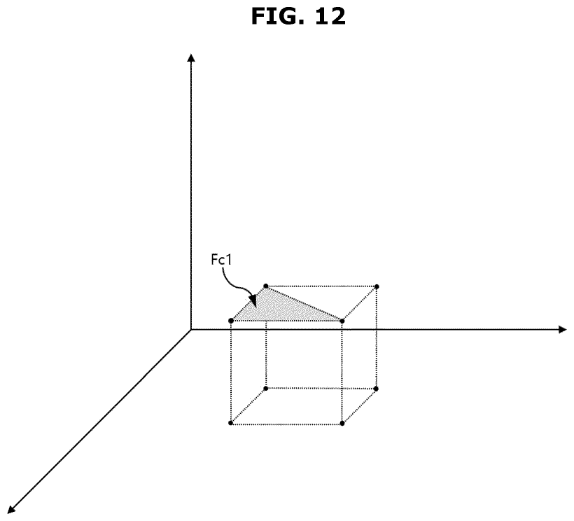

Accordingly, a color image at the first shooting point PP1 will be selected for the first face and texturing for the first face will be performed by matching the local area (P1Fc1) in the color image at the first shooting point PP1 to the first face, as shown in FIG. 12.

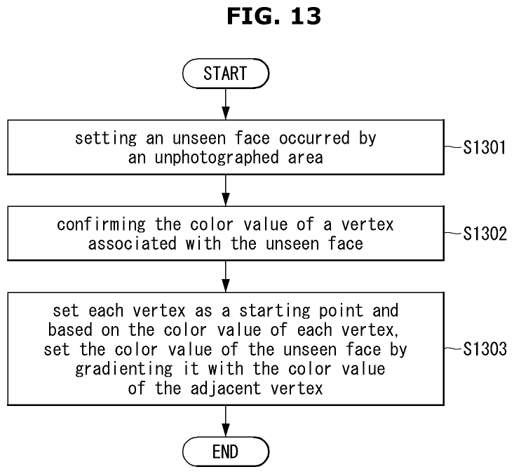

FIG. 13 is a flowchart explaining a method of setting an unseen face for creating a 3D virtual model according to an embodiment disclosed in the present application.

Color image mapping and texturing are performed for each face through the above-described processes, but for some faces, the image to be mapped may not be selected. This face is commonly referred to as an unseen face which occurs in a part that is impossible to shoot in view of the image shooting angle.

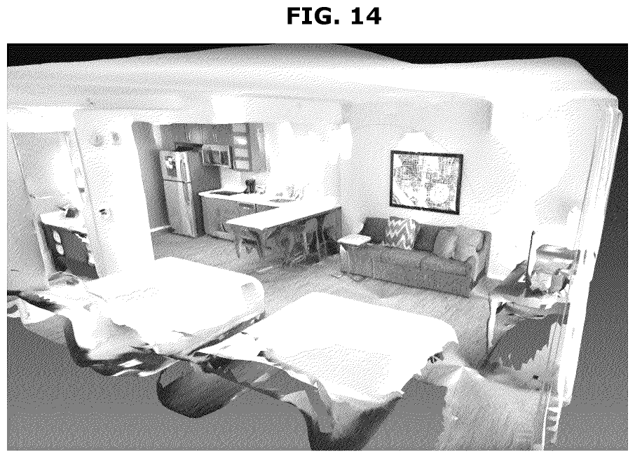

FIG. 14 shows a 3D model in which the unseen face is shown. The unseen face is displayed in blue, and it can be seen that the unseen face occurs behind the bed's bedding, under the sink, and in areas obscured by the table, etc.

The computing device 300 may perform color filling on this unseen face as shown in FIG. 13.

Referring to FIG. 13, the computing device 300 may set an unseen face occurred by an unshot area (S1301). The computing device 300 may set a face without a color image mapped to the face as an unseen face.

The computing device 300 checks the color value of each of the plurality of vertices associated with the unseen face (S1302).

For example, in case of a triangle where each face has three vertices, the computing device 300 may check the color values of the three vertices that configure the unseen face.

As an example, the color value of the vertex may be determined as a pixel value of a color image corresponding to a pixel of a depth image configuring the vertex. That is, the computing device 300 may select a depth image used to derive location information to determine any vertex, and may also select a color image configuring the same data set as the depth image. The computing device 300 may select a vertex-associated depth pixel corresponding to a vertex in the corresponding depth image, and may also select a vertex associated color pixel, which corresponds to a vertex-associated depth pixel selected in the depth image, from the color image. The computing device 300 may set the color value of the vertex-associated color pixel as the color value of the corresponding vertex.

The computing device 300 may fill the unseen face based on the color value of each of the plurality of vertices.

For example, the computing device 300 may set each vertex as a starting point and set the color value of the unseen face by gradienting it with the color value of the adjacent vertex based on the color value of each vertex (S1303). Here, the gradient refers to a technique of changing the color set by color gradation, and this gradation technique can be applied in various ways.

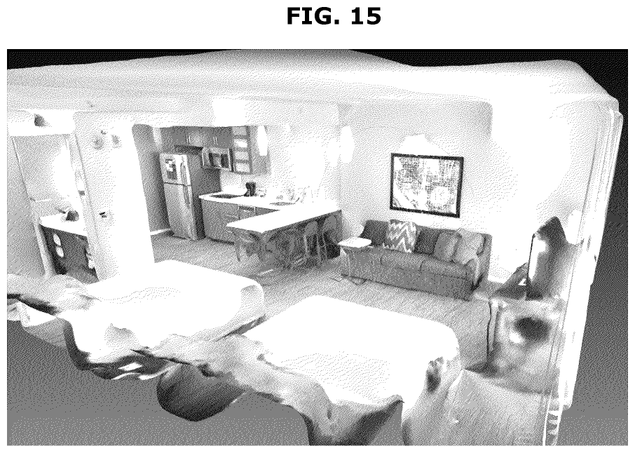

FIG. 15 illustrates an example in which the unseen face is filled with respect to the example in FIG. 14. In the illustrated example, it can be seen that the unseen face is filled based on a color gradation. Texturing of the unseen face by such a gradient itself causes a somewhat unnatural feeling compared to the surrounding colors, but can be compensated for more naturally through the color correction process described below.

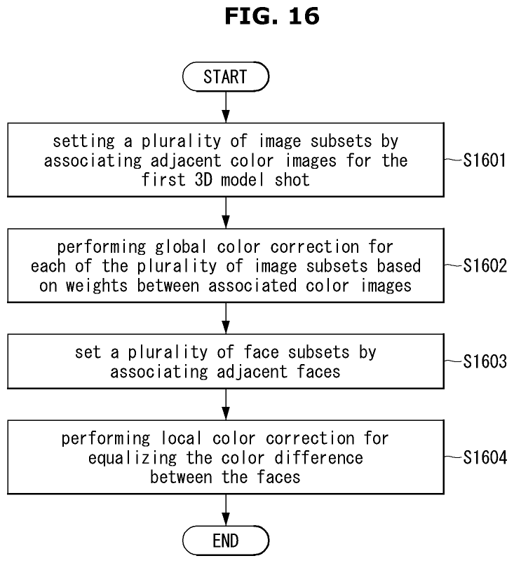

FIG. 16 is a flowchart explaining a color correction method for creating a 3D virtual model according to an embodiment disclosed in the present application.

As described above, the same surface may be displayed in different colors due to different shooting environments between indoor shooting points. In particular, when several faces are adjacent to each other to form one continuous surface or curved surface, the difference in color values of each face gives an unnatural feeling.

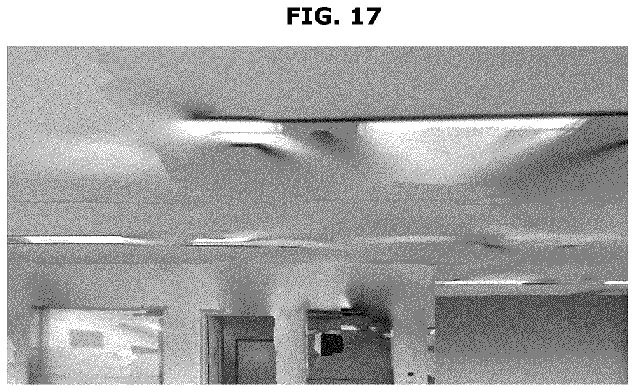

FIG. 17 illustrates a portion of the 3D model before color correction is performed, and in the example of FIG. 17, it can be seen that significant color stains occur for the same wall surface. The computing device 300 provides processing to compensate for such color distortion, that is, color distortion caused by differences in shooting environments between indoor shooting points, which will be described with reference to FIG. 16.

Referring to FIG. 16, the computing device 300 may perform correction between color images and correction between adjacent faces for the first 3D model for which texturing has been completed.

The computing device 300 may set image subsets by associating color images shot at adjacent shooting points (S1601). A plurality of such color image subsets may be set. The computing device 300 may perform global color correction for each color image subset based on correction weights between color images associated with the corresponding color image subsets (S1602). This global color correction is performed on the entire images.

As art example, the computing device 300 may determine a dominant color for color images associated with the color image subsets. In the example of FIG. 17, the dominant color may be gray, and a dominant color weight may be set for gray which is the dominant color for the color images associated with FIG. 17, respectively.

The dominant color weight can be set from the difference between the average values for the dominant color of the associated color images. The larger the color image whose dominant color differs from the average value, the larger the correction weight is set, and color correction can be performed based on the correction weight for each color image. When global color correction is performed in this way, the color image itself has been corrected, and texturing can be re-performed based on this corrected image.

Thereafter, computing device 300 may perform local color correction based on the difference between the faces.

The computing device 300 may establish a plurality of face subsets by associating adjacent faces (S1603).

The computing device 300 may perform local color correction fir each face subset by setting to equalize the color difference between the faces configuring the face subset (S1604). Since this color difference equalization can be applied in various ways, it is not limited to a specific method here.

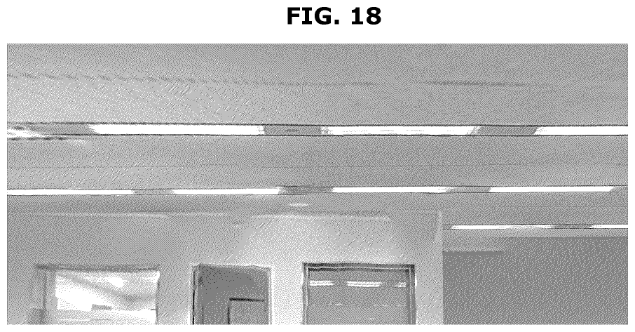

FIG. 18 shows an example in which global color correction and local color correction are applied to the example of FIG. 17. In FIG. 17, it can be seen that parts that had large color differences have been corrected as significantly similar colors.

Since real users feel that if there are multiple colors for the same surface or curved surface, it is quite unnatural, the color correction plays a significant role in providing realistic images of real 3D model.

In the present invention, such color correction is used in combination with global correction and local correction, and the present invention, in which the shooting points are considerably spaced apart and resultantly differences in the shooting conditions are large, can express the 3D model more naturally through this combined color correction.

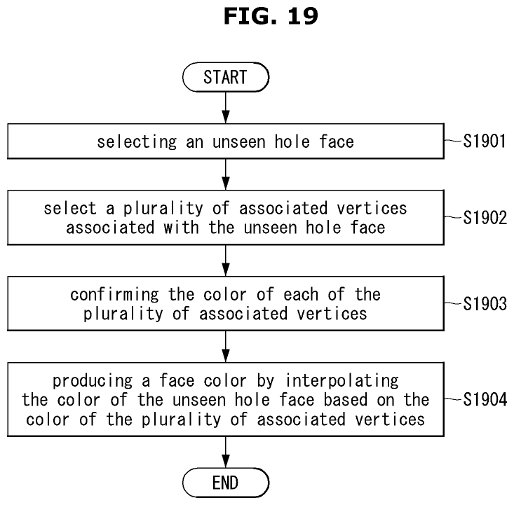

FIG. 19 is a flowchart illustrating an unseen area texturing method for creating a 3D virtual model according to an embodiment disclosed in the present application.

Referring to FIG. 19, the computing device 300 may select a hole face, which is displayed as hole because an appropriate color image was not selected, from among the plurality of faces of the 3D mesh model (S1901). This hole face occurs at a blind spot during shooting, and thus it is referred to as an unseen hole face occurred by an unseen area.

The computing device 300 may select a plurality of associated vertices associated with the unseen hole face (S1902).

The computing device 300 may perform a texturing by checking the color of each of the selected plurality of associated vertices (S1903) and setting the color of the unseen hole face by an interpolation based on the color of the checked plurality of associated vertices (S1902).

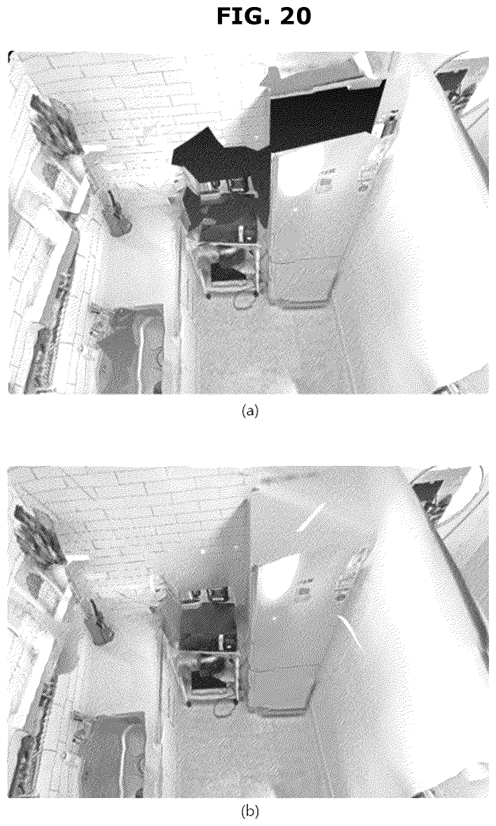

FIG. 20 is a diagram illustrating an example of texturing an unseen area according to an embodiment disclosed in the present application. FIG. 20(a) shows an example where an unseen area occurred, and FIG. 20(b) shows an example where the unseen area was textured.

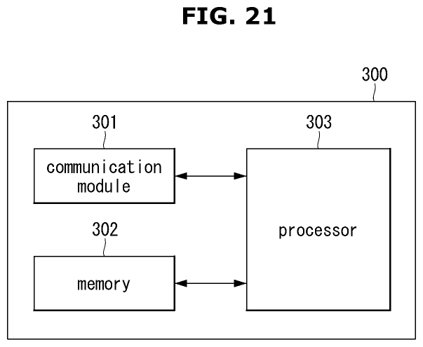

FIG. 21 is a block diagram illustrating a computing device according to an embodiment disclosed in the present application.

As shown in FIG. 21, the computing device 300 according to an embodiment of the present disclosure may include a communication module 310, a memory 320 and a processor 330.

However, this configuration is exemplary, and of course, in implementing the present disclosure, new configurations may be added in addition to this configuration or some configurations may be omitted.

The communication module 310 may include a circuitry and perform communication with external devices (including a server). Specifically, the processor 330 may receive various data or information from external devices connected through the communication module 310, and also transmit various data or information to the external device.

The communication module 310 may include at least one of a WiFi module, a Bluetooth module, a wireless communication module and an NFC module, and perform communications according to various communication standards such as IEEE, Zigbee, 3G (3rd Generation), 3GPP (3rd Generation Partnership Project), LTE (Long Term) and 5G (5th Generation).

At least one command related to the computing device 300 may be stored in the memory 320. An operating system (O/S) for driving the computing device 300 may be stored in the memory 320. Also, the memory 320 may store various software programs or applications fir operating the computing device 300 according to various embodiments of the present disclosure. Additionally, the memory 320 may include a semiconductor memory such as flash memory or a magnetic storage medium such as a hard disk.

Specifically, the memory 320 may store various software modules fir operating the computing device 300 according to various embodiments of the present disclosure, and the processor 330 may control the operation of the computing device 300 by executing various software modules stored in the memory 320.

That is, the memory 320 is accessed by the processor 330, and data read/write/modify/delete/update, etc. may be performed by the processor 330.

In addition, various information necessary within the scope of achieving the purpose of the present disclosure may be stored in the memory 320, and the information stored in the memory 320 may be updated as it is received from an external device or inputted by the user.

Processor 330 may be comprised of one or more processors.

The processor 330 controls the overall operation of the computing device 300. Specifically, the processor 330 is connected to the configuration of the computing device 300 including the communication unit 301 and the memory 320 as described above, and executes at least one command stored in the memory 320 as described above to thereby control the overall operations of the computing device 300.

Processor 330 may be implemented in various ways.

For example, the processor 330 may implemented as at least one of an application specific integrated circuit (ASIC), an embedded processor, a microprocessor, hardware control logic, a hardware finite state machine (FSM) and a digital signal processor (DSP). Meanwhile, the term processor as used in the present disclosure may include a central processing unit (CPU), a graphics processing unit (GPU) and a main processing unit (MPU).

Meanwhile, the control method performed by the computing device 300 according to the above-described embodiment may be implemented as a program and applied to the computing device 300. For example, a program including a control method for the computing device 300 may be stored in a non-transitory computer readable medium.

In the above, a control method of the computing device 300 and the computer-readable recording medium including the program for executing the control method of the computing device 300 have been briefly described to omit redundant description. Of course, various embodiments of an electronic device 100 can also be applied to the control method of the computing device 300 and a computer-readable recording medium including a program that executes the control method of the computing device 300.

Meanwhile, a storage medium that can be read by a device may be provided in the form of a non-transitory storage medium.

Here, ‘non-transitory storage medium’ simply means that it is a tangible device and does not contain signals (e.g. electromagnetic waves). This term does not distinguish between a case where data is semi-permanently stored in a storage medium and a case where data is temporarily stored in the storage media. For example, a ‘non-transitory storage medium’ may include a buffer where data is temporarily stored.

The present invention described above is not limited by the above-described embodiments and the accompanying drawings, but is limited by the scope of the claims described later. A person skilled in the art will easily appreciate that the configuration of the present invention can be varied and modified in a variety of ways within the scope without departing from the technical spirit of the present invention.

### Acknowledgement

This invention was applied for international patent with the support of the fallowing research project supported by the Korean government

### Research Project Information

Name of Department: Korea Tourism Organization
Name of research project: Follow-up support for global leading tourism companies
Task Name: Smartphone interlocking automatic recognition and tracking photographing device
Organization: 3I INC.
Project Period: 2022.03.04-2022.12.31

### INDUSTRIAL APPLICABILITY

The invention is highly industrial use because it has effect that is capable of accurately filling the hole face with efficient resources by filling the hole face using the point color of the point cloud.

In addition, the invention is highly industrial use because it has the effect that is capable of more accurate texturing even in a 3D creation environment based on images shot at various points spaced apart from each other in indoor space by effectively selecting an image suitable for the face of a 3D model.

In addition, the invention is highly industrial use because it has the effect that is capable of accurately compensating the color imbalance caused by different shooting conditions between various points in indoor space to thereby minimize the sense of heterogeneity on each side of the virtual indoor space and provide a texture of a virtual space more similar to the real space.

What is claimed is:

1. A texturing method, performable on a computing device, for creating a 3D virtual model based on a plurality of data sets, each of which is created from a plurality of shooting points in an indoor space and includes a color image and a depth image, comprising:
creating a 3D mesh model based on the created plurality of data sets;
texturing each of the plurality of faces included in the 3D mesh model based on an association between the face and the color image;
identifying a hole face that is displayed as a hole due to the absence of the association; and
confirming a plurality of associated vertices associated with the hole face and setting a color of the hole face based on the colors of the confirmed plurality of associated vertices.

2. The method according to claim 1, wherein the creating the 3D mesh model includes:
setting the plurality of shooting points as a plurality of 3D reference coordinates;
creating point cloud data including a plurality of points set in a 3D space by reflecting the color image data and the depth image data created from the plurality of shooting points into the 3D reference coordinates; and
setting a plurality of vertices by selecting at least some of the plurality of points.

3. The method according to claim 2, wherein the plurality of vertices configure the 3D mesh model, the each vertex including color data being set based on a color image data associated with the vertex.

4. The method according to claim 1, wherein the texturing each of the plurality of faces included in the 3D mesh model comprises:
selecting one color image for the each face by calculating a plurality of weight factors for each of a plurality of color images associated with the each face and determining the association based on the calculated plurality of weight factors; and
performing texturing by mapping a local area corresponding to a corresponding face among selected color images to the corresponding face.

5. The method according to claim 4, wherein the texturing each of the plurality of faces included in the 3D mesh model comprises:
for each of the plurality of color images associated with each face, calculating a first weight factor for directional association based on a directional vector for the corresponding face;
for each of the plurality of color images associated with each face, calculating a second weight factor for the resolution of the corresponding color image;
calculating the association based on the first weight factor and the second weight factor; and
selecting one color image with the highest association.

6. The method according to claim 4, wherein the texturing each of the plurality of faces included in the 3D mesh model comprises:
for each of the plurality of color images associated with each face, calculating a first weight factor for directional association based on a direction vector for the corresponding face;
for each of the plurality of color images associated with each face, calculating a third weight factor based a color noise;
calculating the association based on the first weight factor and the second weight factor; and
selecting one color image with the highest association.

7. The method according to claim 4, wherein the texturing each of the plurality of faces included in the 3D mesh model comprises:
for each of the plurality of color images associated with each face, calculating a first weight factor for directional association based on a direction vector for the corresponding face;
for each of the plurality of color images associated with each face, calculating a second weight factor for the resolution of the corresponding color image;
for each of the plurality of color images associated with each face, calculating a third weight factor based on color noise;
calculating the association based on the first to third weight factors; and
selecting one color image with the highest association.

8. The method according to claim 3, wherein the confirming a plurality of associated vertices associated with the hole face and setting a color of the hole face based on the colors of the confirmed plurality of associated vertices comprises:
setting a plurality of vertices corresponding to vertices of the hole face as the plurality of associated vertices;
confirming color data of each of the plurality of associated vertices;
setting the color of the hole face by color-interpolating the color data of the plurality of associated vertices.

9. A computing device comprising a memory for storing one or more instructions and at least one processor for executing the one or more instructions stored in the memory, wherein the one or more instructions cause, when executed by the at least one processor, the at least one processor to:
prepare a plurality of data sets, each of which is created from a plurality of shooting points in an indoor space and includes a color image and a depth image;
create a 3D mesh model based on the created plurality of data sets;
texture each of the plurality of faces included in the 3D mesh model based on an association between the face and the color image;
identify a hole face that is displayed as a hole due to the absence of the association; and
confirm a plurality of associated vertices associated with the hole face and set a color of the hole face based on the colors of the confirmed plurality of associated vertices.

10. The computing device according to claim 9, wherein the computing device is configured to:
set the plurality of shooting points as a plurality of 3D reference coordinates;
create point cloud data including a plurality of points set in a 3D space by reflecting the color image data and the depth image data created from the plurality of shooting points into the 3D reference coordinates; and
set a plurality of vertices by selecting at least some of the plurality of points.

11. The computing device according to claim 10, wherein the plurality of vertices configure the 3D mesh model, the each vertex including color data being set based on a color image data associated with the vertex.

12. The computing device according to claim 9, wherein the computing device is configured to:
select one color image for the each face by calculating a plurality of weight factors for each of a plurality of color images associated with the each face and determining the association based on the calculated plurality of weight factors; and
perform texturing by mapping a local area corresponding to a corresponding face among selected color images to the corresponding face.

13. The computing device according to claim 12, wherein the computing device is configured to:
for each of the plurality of color images associated with each face, calculate a first weight factor for directional association based on a directional vector for the corresponding face;
for each of the plurality of color images associated with each face, calculate a second weight factor for the resolution of the corresponding color image;
calculate the association based on the first weight factor and the second weight factor; and
select one color image with the highest association.

14. The computing device according to claim 12, wherein the computing device is configured to:
for each of the plurality of color images associated with each face, calculate a first weight factor for directional association based on a direction vector for the corresponding face;
for each of the plurality of color images associated with each face, calculate a third weight factor based a color noise;
calculate the association based on the first weight factor and the second weight factor; and
select one color image with the highest association.

15. The computing device according to claim 12, wherein the computing device is configured to:
for each of the plurality of color images associated with each face, calculate a first weight factor for directional association based on a direction vector for the corresponding face;
for each of the plurality of color images associated with each face, calculate a second weight factor for the resolution of the corresponding color image;
for each of the plurality of color images associated with each face, calculate a third weight factor based on color noise;
calculate the association based on the first to third weight factors; and
select one color image with the highest association.

16. The computing device according to claim 11, wherein the computing device is configured to:
set a plurality of vertices corresponding to vertices of the hole face as the plurality of associated vertices;
confirm color data of each of the plurality of associated vertices; and
set the color of the hole face by color-interpolating the color data of the plurality of associated vertices.

17. A storage medium storing computer-readable instructions,
wherein the instructions, when executed by a computing device, cause the computing device to perform the operations of:
preparing a plurality of data sets, each of which is created from a plurality of shooting points in an indoor space and includes a color image and a depth image;
creating a 3D mesh model based on the created plurality of data sets;
texturing each of the plurality of faces included in the 3D mesh model based on an association between the face and the color image;
identifying a hole face that is displayed as a hole due to the absence of the association; and
confirming a plurality of associated vertices associated with the hole face and set a color of the hole face based on the colors of the confirmed plurality of associated vertices,
storage media.
